(19) United States
(12) Patent Application Publication
(10) Pub. No.: US 2006/0166704 A1
(43) Pub. Date: Jul. 27, 2006

(54) Method for alerting a subscriber of an emergency call request

(76) Inventors: David S. Benco, Winfield, IL (US); Sanjeev Mahajan, Naperville, IL (US); Baoling S. Sheen, Naperville, IL (US); Sandra Lynn True, St. Charles, IL (US)

Correspondence Address: Lucent Technologies Inc.;Docket Administrator - Room 3J-219, 101 Crawfords Corner Road, Holmdel, NJ, 07733-3030, US

(21) Appl. No.: 11/043,203

(22) Filed: Jan. 26, 2005

(51) Int. Cl. H04M 1/00

(52) U.S. Cl. 455/567; 455/404.1

(57) ABSTRACT

The present invention provides a method for alerting a communication unit of an emergency call request from an emergency calling unit. A Mobile Switching Center (MSC) receives an emergency call request from an emergency calling unit. The MSC determines if a communication unit should be alerted of the emergency call request. If so, the MSC alerts the communication unit of the emergency call request. The alert can include information about the emergency call request, such as the directory number of the emergency calling unit, the time that the emergency call was placed, or the location of the emergency calling unit.

### FIELD OF THE INVENTION

The present invention relates generally to emergency calls in telecommunications systems.

### BACKGROUND OF THE INVENTION

Emergency telecommunication service, such as 911 service, allows a user of a telecommunications system to be connected quickly with emergency personnel, such as police or fire departments. As the name implies, such calls are typically placed by a user who is in an emergency situation.

A user who places an emergency call may be unable to contact friends or family to alert them to the current difficulty. In the case of an accident or the like, family and loved ones may not become aware of the emergency situation until hours after the event has occurred.

Therefore, a need exists for a method of providing notice to friends and family of a user who is experiencing an emergency situation.

### BRIEF SUMMARY OF THE INVENTION

The present invention provides a method for alerting an alerted unit of an emergency call request. An emergency calling unit places an emergency call, and a separate alerted unit is alerted to the placement of the emergency call by the emergency calling unit. The alerted unit can be a wireless or wireline unit.

In an exemplary embodiment, an MSC receives an emergency call request from an emergency calling unit, such as a mobile unit. The MSC determines whether it should alert any communication units of the emergency call placed by the emergency calling unit. If there are no communication units to alert, the MSC processes the emergency call request without alerting other communication units.

If there are alerted units associated with the emergency calling unit, the MSC alerts the alerted units of the emergency call request. The emergency calling unit may have one or more alerted units for the emergency alert service.

The alerted unit contacted upon an emergency call can vary. Further, the alert sent to alerted units can include various pieces of information, such as the directory number of the emergency calling unit, the time that the emergency call was placed, and the location of the emergency calling unit.

### BRIEF DESCRIPTION OF THE SEVERAL VIEWS OF THE DRAWINGS

FIG. 1 depicts a communication system in accordance with an exemplary embodiment of the present invention.

FIG. 2 depicts a flowchart of a method for alerting a subscriber of an emergency call request in accordance with an exemplary embodiment of the present invention.

FIG. 3 depicts a table including an emergency calling unit number and an alerted unit number in accordance with an exemplary embodiment of the present invention.

### DETAILED DESCRIPTION OF THE INVENTION

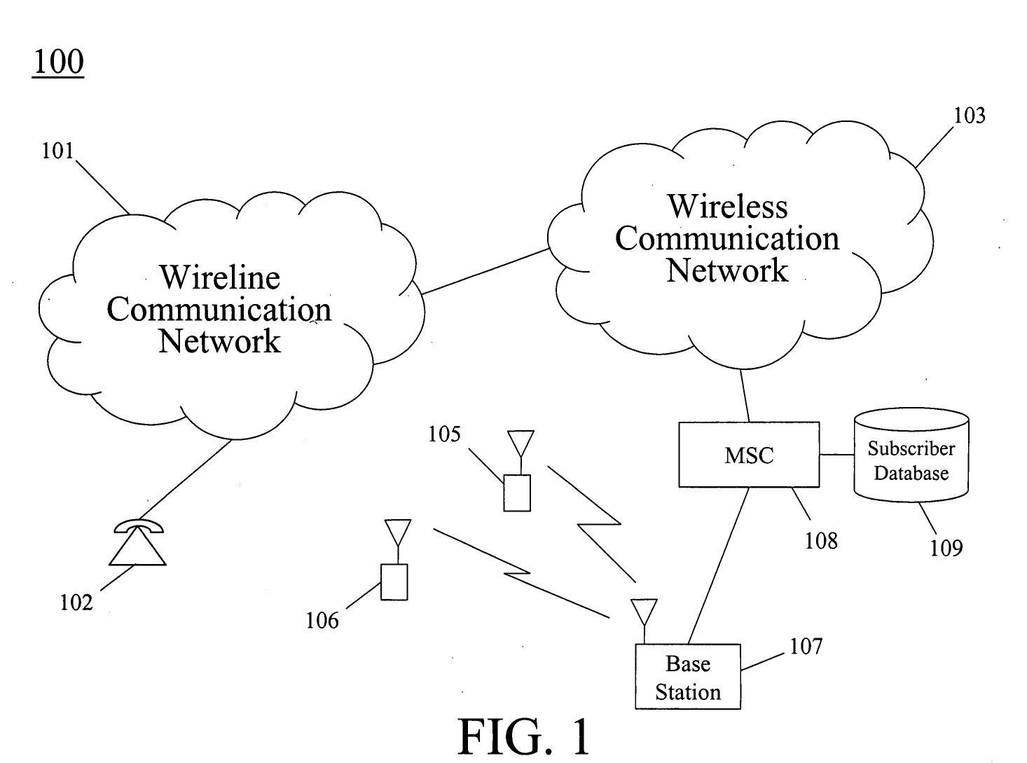

FIG. 1 depicts a communication system 100 in accordance with an exemplary embodiment of the present invention. Communication system 100 includes wireline communication network 101 and wireless communication network 103. Communication system 100 may include a plurality of wireless networks, but only wireless communication network 103 is depicted in FIG. 1 for clarity.

Wireline communication network 101 is a wireline network that allows wireline devices to access a telephone network, such as the Public Switched Telephone Network (PSTN). CPE 102 is a telephone unit that allows communication with other users via wireline communication network 101.

Wireless communication network 103 includes at least one Mobile Switching Center (MSC) 108, a base station 107, and a subscriber database 109. Each MSC is connected to a plurality of base stations, although only a single base station 107 is depicted in FIG. 1 for clarity. MSC 108 processes call and service requests initiated by mobile units 105 and 106 and allocates the required transmission and signaling resources.

Wireless communication network 103 can utilize any wireless protocol, including but not limited to analog, such as AMPS, TACS and NMT, or digital, such as GSM, TDMA, CDMA, GPRS, EDGE, IS-95, IS-95B, HDR, WCDMA, and CDMA2000.

Base station 107 communicates with wireless communication network 103 via MSC 108 and communicates over the air with mobile units 105 and 106. Although only one base station and two mobile units are depicted in FIG. 1 for clarity, it should be understood that wireless communication network 103 typically includes a plurality of MSCs, each of which communicates with a plurality of base stations, and each base station services a plurality of wireless units. Base Station 107 is a wireless station that preferably includes connections to the controlling servers via IP or traditional switching mechanisms.

In an exemplary embodiment, mobile units 105 and 106 are wireless phones. In a further exemplary embodiment, mobile units 105 and 106 can be Personal Digital Assistants (PDAs), wireless email terminals, or any other communications device that is capable of communicating with wireless communication network 103.

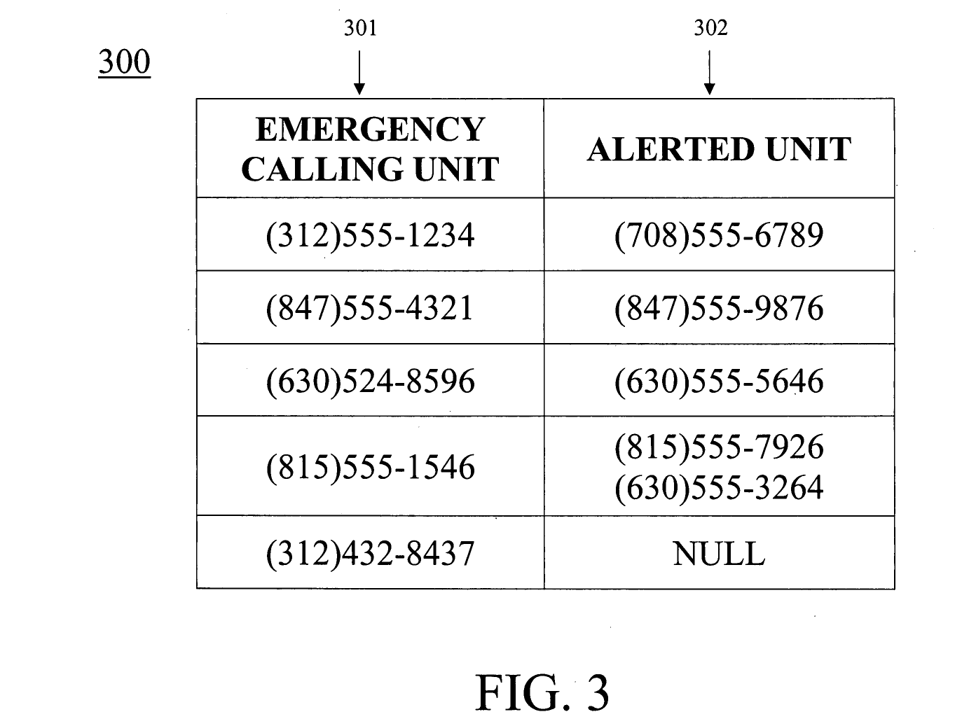

Subscriber database 109 includes information relating to the directory numbers of emergency calling units and alerted units, and is depicted in more detail in FIG. 3 below.

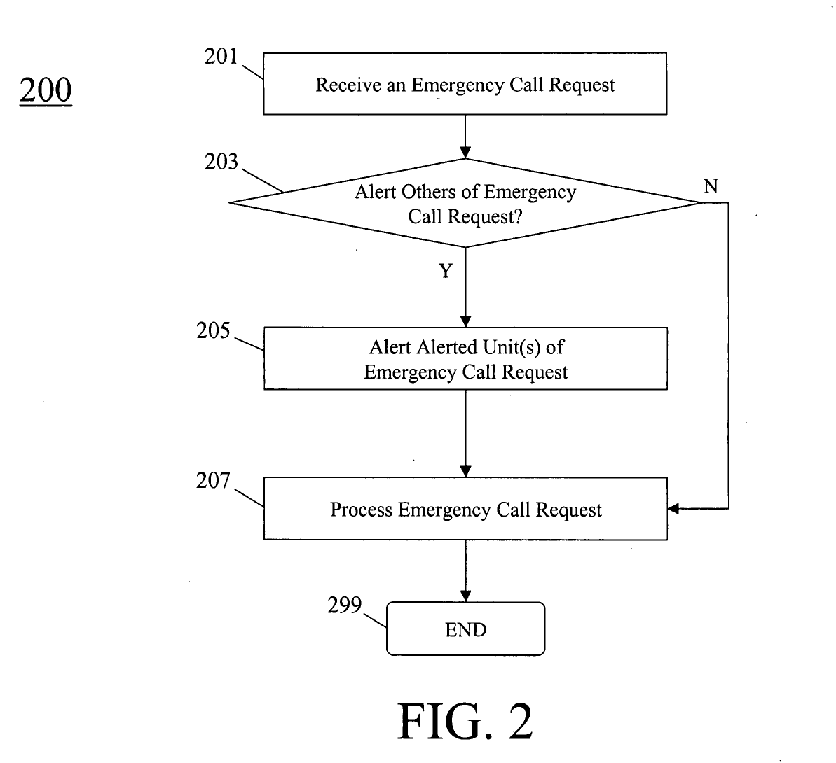

FIG. 2 depicts a flowchart 200 of a method for alerting an alerted unit of an emergency call request in accordance with an exemplary embodiment of the present invention. In this embodiment, an emergency calling unit places an emergency call, and a separate alerted unit is alerted to the placement of the emergency call by the emergency calling unit. The alerted unit can be a wireless or wireline unit.

MSC 108 receives (201) an emergency call request from mobile unit 105. In an exemplary embodiment, mobile unit 105 dials “911” and is connected to a Public Safety Answering Point (PSAP). Attendants at the PSAP take the call and perform necessary routing and information gathering from the user of mobile unit 105.

MSC 108 determines (203) whether it should alert any communication units of the emergency call placed by mobile unit 105. In an exemplary embodiment of the present invention, MSC 108 accesses table 300, described in greater detail in FIG. 3 below, and determines if there are any alerted units associated with the communication unit placing the emergency call. If there are no subscribers to alert, MSC 108 processes (207) the emergency call request without alerting other communication units.

If there are alerted units associated with the emergency calling unit as determined at step 203, MSC 108 alerts (205) the alerted units of the emergency call request. In an exemplary embodiment, the alert is a paging message. In a further exemplary embodiment, the alert is a Short Message Service (SMS) message.

MSC 108 preferably retrieves the directory number from alerted unit field 302 that is associated with the communication unit that placed the emergency call. The emergency calling unit may have one or more alerted units for the emergency alert service. For example, a college student who places an emergency call may desire to have both parents alerted in the case of an emergency call.

In an exemplary embodiment of the present invention, the alerted unit contacted upon an emergency call can vary. For example, an alerted unit may desire to be contacted at her business phone during business hours, such as Monday through Friday from 8:00 a.m. until 5:00 p.m., and on her mobile phone during non-business hours. In this embodiment, a timer can be set, and upon expiration of the timer the alerted unit field is modified. In a further exemplary embodiment, table 300 can include an additional field that specifies a date and/or time, and a different alerted unit directory number is associated with each of the different dates and times.

The alert sent to alerted units can include various pieces of information. In an exemplary embodiment, the directory number of the emergency calling unit and the time that the emergency call was placed are included in the alert.

In a further exemplary embodiment, the location of the emergency calling unit is included in the alert message. The location of the emergency calling unit is preferably transmitted in the emergency call request and forwarded to the alerted unit in the alert message.

MSC 108 then processes (207) the emergency call request.

FIG. 3 depicts a table 300 including an emergency calling unit number and an alerted unit number in accordance with an exemplary embodiment of the present invention. In an exemplary embodiment, table 300 includes two fields, emergency calling unit field 301 and alerted unit field 302.

Emergency calling unit field 301 is a field that includes the directory number of emergency calling units associated with alerted units. In an alternate exemplary embodiment, the emergency calling unit can be the subscriber to the emergency alert service.

Alerted unit field 302 includes a list of directory numbers that have subscribed to the emergency call alert service and that should be contacted upon the placement of an emergency call by an emergency call unit.

In an exemplary embodiment of the present invention, when MSC 108 receives a call request, MSC 108 searches emergency calling unit field 301 of table 300 for the directory number of the emergency calling unit. If MSC 108 finds a match between the directory number of the calling phone and a record in field 301, MSC 108 retrieves the associated directory numbers from alerted unit field 302. Alerted unit field 302 can include a NULL value, which indicates that there is no unit to alert to the emergency call, or may include one or more directory number(s) of communication units that should be alerted to the placement of the emergency call. MSC 108 alerts the subscribers that are located within the associated field.

The present invention thereby provides a method for alerting communication units when an associated communication unit has placed an emergency call. In an exemplary embodiment, upon placement of an emergency call, an MSC determines if the mobile unit placing the emergency call is associated with an alerted unit. If so, the MSC sends a message to the alerted unit to let that unit know that the associated mobile unit has placed an emergency call. The alert message can include information pertaining to the emergency call, such as the date, time, or location of the mobile unit at the time of the emergency call.

The present invention thereby provides friends and relatives of a person who is in an emergency situation an almost immediate alert to the placement of the emergency call. This alert can allow the alerted party to take necessary steps to assist and get information pertaining to the emergency and the call request.

While this invention has been described in terms of certain examples thereof, it is not intended that it be limited to the above description, but rather only to the extent set forth in the claims that follow.

We claim:

1. A method for alerting a communication unit of an emergency call request from an emergency calling unit, the method comprising:
receiving an emergency call request from an emergency calling unit;
determining if a communication unit should be alerted of the emergency call request; and
if a communication unit should be alerted to the emergency call request, alerting the communication unit of the emergency call request.

2. A method for alerting a communication unit of an emergency call request from an emergency calling unit in accordance with claim 1, wherein the step of alerting the communication unit of the emergency call request comprises sending a paging message to the communication unit.

3. A method for alerting a communication unit of an emergency call request from an emergency calling unit in accordance with claim 1, wherein the step of alerting the communication unit of the emergency call request comprises sending an SMS message to the communication unit.

4. A method for alerting a communication unit of an emergency call request from an emergency calling unit in accordance with claim 1, wherein the step of determining if a communication unit should be alerted of the emergency call request comprises accessing a table.

5. A method for alerting a communication unit of an emergency call request from an emergency calling unit in accordance with claim 1, wherein the step of alerting the communication unit of the emergency call request comprises retrieving a directory number that is associated with the emergency calling unit.

6. A method for alerting a communication unit of an emergency call request from an emergency calling unit in accordance with claim 1, further comprising the step of alerting a second communication unit of the emergency call request.

7. A method for alerting a communication unit of an emergency call request from an emergency calling unit in accordance with claim 1, wherein the step of alerting the communication unit of the emergency call request comprises alerting a first communication unit at a first time and a second communication unit at a second time.

8. A method for alerting a communication unit of an emergency call request from an emergency calling unit in accordance with claim 1, wherein the step of alerting the communication unit of the emergency call request comprises sending an alert message to the communication unit, the alert message including information about the emergency call request.

9. A method for alerting a communication unit of an emergency call request from an emergency calling unit in accordance with claim 8, wherein the alert message includes the directory number of the emergency calling unit.

10. A method for alerting a communication unit of an emergency call request from an emergency calling unit in accordance with claim 8, wherein the alert message includes the time that the emergency call was placed.

11. A method for alerting a communication unit of an emergency call request from an emergency calling unit in accordance with claim 8, wherein the alert message includes the location of the emergency calling unit.

12. A Mobile Switching Center (MSC) for processing an emergency call request, the MSC comprising:
means for receiving an emergency call request from an emergency calling unit; and
means for alerting a communication unit of the emergency call request if the MSC determines that the communication unit should be alerted to the emergency call request.

13. An MSC in accordance with claim 12, wherein the means for alerting a communication unit of the emergency call request comprises means for sending a paging message to the communication unit.

14. An MSC in accordance with claim 12, wherein the means for alerting a communication unit of the emergency call request comprises means for sending an SMS message to the communication unit.

15. An MSC in accordance with claim 12, the MSC further comprising means for alerting a second communication unit of the emergency call request.

16. An MSC in accordance with claim 12, wherein the means for alerting a communication unit of the emergency call request comprises means for alerting a first communication unit at a first time and means for alerting a second communication unit at a second time.

17. An MSC in accordance with claim 12, wherein the means for alerting a communication unit of the emergency call request comprises means for sending an alert message to the communication unit, the alert message including information about the emergency call request.

18. An MSC in accordance with claim 17, wherein the alert message includes the directory number of the emergency calling unit.

19. An MSC in accordance with claim 17, wherein the alert message includes the time that the emergency call was placed.

20. An MSC in accordance with claim 17, wherein the alert message includes the location of the emergency calling unit.
